(19) United States
(12) Patent Application Publication
(10) Pub. No.: US 2017/0338700 A1
(43) Pub. Date: Nov. 23, 2017

(54) ROTARY MACHINE INCLUDING ROTOR, STATOR, AND INSERTION MEMBER

(71) Applicant: Panasonic Intellectual Property Management Co., Ltd., Osaka (JP)

(72) Inventors: AKIRA KATO, Osaka (JP); KAZUYUKI SAKIYAMA, Osaka (JP); TAKEHIKO YAMAKAWA, Osaka (JP)

(21) Appl. No.: 15/497,780

(22) Filed: Apr. 26, 2017

(30) Foreign Application Priority Data
May 19, 2016 (JP) 2016-100925

(51) Int. Cl. H02K 1/18; H02K 1/28

(52) U.S. Cl. CPC H02K 1/18; H02K 1/28

(57) ABSTRACT

A rotary machine includes a rotor, a stator, a first hole and a second hole that are provided in at least one selected from the group consisting of the rotor and the stator, and a first insertion member including a first protrusion inserted into the first hole, a second protrusion inserted into the second hole, and a first connection connecting the first protrusion and the second protrusion to each other. A distance between the first hole and the second hole differs from a length of the first connection.

### BACKGROUND

### 1. Technical Field

The present disclosure relates to a rotary machine that is an electric motor or a generator.

### 2. Description of the Related Art

In a rotary machine of the related art, a tensile stress is applied to a tooth portion of the rotary machine such that a compressive stress is not concentrated on the tooth portion near its root in order to improve the magnetic characteristics of the tooth portion and reduce iron loss. Such a rotary machine is disclosed in Japanese Unexamined Patent Application Publication No. 2010-178599 as described below.

The rotary machine includes a stator core formed of electrical steel sheets stacked in the axial direction of a rotor. The stator core includes a cylindrical yoke, tooth portions that protrude from the yoke inward in the radial direction of the rotor and that are arranged in the circumferential direction of the yoke. Each of the tooth portions has a tip portion having an increased width in the circumferential direction. The rotary machine also includes protrusions and stress-applying members. The protrusions protrude from the respective end portions of the stator core in the direction parallel to the axial direction of the rotor and are located at least outside the respective tooth portions around the yoke. The stress-applying members are disposed on the respective tooth portions and are each pressed to a side surface of the corresponding tip portion and protrusion. Each of the stress-applying members applies a tensile stress to the corresponding tooth portion in the direction in which the tooth portion extends.

### SUMMARY

In one general aspect, the techniques disclosed here feature a rotary machine including a rotor, a stator, a first hole and a second hole that are provided in at least one selected from the group consisting of the rotor and the stator, and a first insertion member including a first protrusion inserted into the first hole, a second protrusion inserted into the second hole, and a first connection connecting the first protrusion and the second protrusion to each other. A distance between the first hole and the second hole differs from a length of the first connection.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1A is a plan view of a rotary machine according to a first embodiment;

FIG. 1B is a sectional view of the rotary machine taken along line IB-IB in FIG. 1A;

FIG. 2A is a plan view of the rotary machine in FIG. 1A before insertion members are inserted;

FIG. 2B is an enlarged view of a portion IIB in FIG. 2A;

FIG. 3 is a side view of one of the insertion members used in the rotary machine in FIG. 1A;

FIG. 4 is a graph illustrating iron loss with respect to the output power of the rotary machine in FIG. 1A in the case where a tensile stress is applied and in the case where no tensile stress is applied;

FIG. 5 is a plan view of a rotary machine according to a second embodiment;

FIG. 6A is a plan view of the rotary machine in FIG. 5 before the insertion members are inserted;

FIG. 6B is an enlarged view of a portion VIB in FIG. 6A;

FIG. 7A is a plan view of a rotary machine according to a third embodiment;

FIG. 7B is an enlarged view of a portion VIIB in FIG. 7A;

FIG. 8A is a plan view of a rotary machine according to a fourth embodiment;

FIG. 8B is an enlarged view of a portion VIIIB in FIG. 8A;

FIG. 9 is a sectional view of a rotary machine according to a fifth embodiment;

FIG. 10A is a plan view of a rotary machine according to a modification; and

FIG. 10B is an enlarged view of a portion XB in FIG. 10A.

### DETAILED DESCRIPTION

The above-described rotary machine of the related art has a problem in that the degree of freedom of design for the tip of each tooth portion is limited and the stress-applying members is not able to be mounted depending on the shape of the tip of the tooth portion.

In contrast, the rotary machine according to an aspect of the present disclosure enables a stress to be applied to at least one selected from the group consisting of a rotor and a stator more easily than the related art.

The present disclosure includes rotary machines according to the following aspects.

### First Aspect

A rotary machine according to a first aspect of the present disclosure includes

a rotor,

a stator,

a first hole and a second hole that are provided in at least one selected from the group consisting of the rotor and the stator, and

a first insertion member including a first protrusion inserted into the first hole, a second protrusion inserted into the second hole, and a first connection connecting the first protrusion and the second protrusion to each other.

A distance between the first hole and the second hole differs from the length of the first connection.

### Second Aspect

The rotary machine according to the first aspect of the present disclosure may further include a frame holding the outer edge of the stator.

### Third Aspect

The rotary machine according to the first aspect of the present disclosure may further include

a third hole and a fourth hole that are provided in at least one selected from the group consisting of the rotor and the stator, and

a second insertion member including a third protrusion inserted into the third hole, a fourth protrusion inserted into the fourth hole, and a second connection connecting the third protrusion and the fourth protrusion to each other.

The distance between the first hole and the second hole may be shorter than the length of the first connection.

A distance between the third hole and the fourth hole may be longer than the length of the second connection.

With such a structure, for example, a tensile stress can be applied to a location at which the first insertion member is disposed, and a compressive stress can be applied to a location at which the second insertion member is disposed.

### Fourth Aspect

The rotary machine according to the first aspect of the present disclosure may further include

a third hole and a fourth hole that are provided in at least one selected from the group consisting of the rotor and the stator, and

a second insertion member including a third protrusion inserted into the third hole, a fourth protrusion inserted into the fourth hole, and a second connection connecting the third protrusion and the fourth protrusion to each other.

The distance between the first hole and the second hole may be shorter than the length of the first connection.

A distance between the third hole and the fourth hole may be shorter than the length of the second connection.

### Fifth Aspect

The rotary machine according to the first aspect of the present disclosure may further include

a third hole and a fourth hole that are provided in at least one selected from the group consisting of the rotor and the stator, and

a second insertion member including a third protrusion inserted into the third hole, a fourth protrusion inserted into the fourth hole, and a second connection connecting the third protrusion and the fourth protrusion to each other.

The distance between the first hole and the second hole may be longer than the length of the first connection.

A distance between the third hole and the fourth hole may be longer than the length of the second connection.

### Sixth Aspect

In the rotary machine according to the third aspect of the present disclosure,

the stator may include a first tooth and a second tooth.

The first hole and the second hole may be provided in the first tooth.

The third hole and the fourth hole may be provided in the second tooth.

### Seventh Aspect

The rotary machine according to the first aspect of the present disclosure may further include

a third hole connected to the first hole,

a fourth hole connected to the second hole, and

a second insertion member including a third protrusion inserted into the third hole, a fourth protrusion inserted into the fourth hole, and a second connection connecting the third protrusion and the fourth protrusion to each other.

The at least one selected from the group consisting of the rotor and the stator may have a first surface perpendicular to a shaft of the rotary machine and a second surface opposite to the first surface.

The first hole and the second hole may extend from the first surface.

The third hole and the fourth hole may extend from the second surface.

### Eighth Aspect

The rotary machine according to the third aspect of the present disclosure may further include

a fifth hole connected to the first hole,

a sixth hole connected to the second hole,

a third insertion member including a fifth protrusion inserted into the fifth hole, a sixth protrusion inserted into the sixth hole, and a third connection connecting the fifth protrusion and the sixth protrusion,

a seventh hole connected to the third hole,

an eighth hole connected to the fourth hole, and

a fourth insertion member including a seventh protrusion inserted into the seventh hole, an eighth protrusion inserted into the eighth hole, and a fourth connection connecting the seventh protrusion and the eighth protrusion to each other.

The at least one selected from the group consisting of the rotor and the stator may have a first surface perpendicular to a shaft of the rotary machine and a second surface opposite to the first surface.

The first hole, the second hole, the third hole, and the fourth hole may extend from the first surface.

The fifth hole, the sixth hole, the seventh hole, and the eighth hole may extend from the second surface.

### Ninth Aspect

In the rotary machine according to the eighth aspect of the present disclosure,

a distance between the fifth hole and the sixth hole may be shorter than the length of the third connection and

a distance between the seventh hole and the eighth hole may be longer than the length of the fourth connection.

### Tenth Aspect

In the rotary machine according to the first aspect of the present disclosure,

the first insertion member may be composed of a non-magnetic material.

### Eleventh Aspect

In the rotary machine according to the first aspect of the present disclosure,

the first insertion member may be composed of an insulating material.

### Twelfth Aspect

In the rotary machine according to the third aspect of the present disclosure, the first insertion member and the second insertion member may be composed of a non-magnetic material.

### Thirteenth Aspect

In the rotary machine according to the third aspect of the present disclosure,

the first insertion member and the second insertion member may be composed of an insulating material.

### Fourteenth Aspect

In the rotary machine according to the seventh aspect of the present disclosure,

the first insertion member and the second insertion member may be composed of a non-magnetic material.

### Fifteenth Aspect

In the rotary machine according to the seventh aspect of the present disclosure,

the first insertion member and the second insertion member may be composed of an insulating material.

The rotary machine according to any one of the first to fifteenth aspects of the present disclosure may be an electric motor or a generator.

Embodiments of the present disclosure will hereinafter be described with reference to the drawings. In the embodiments, like components are designated by like symbols, and a detailed description thereof is omitted.

### First Embodiment

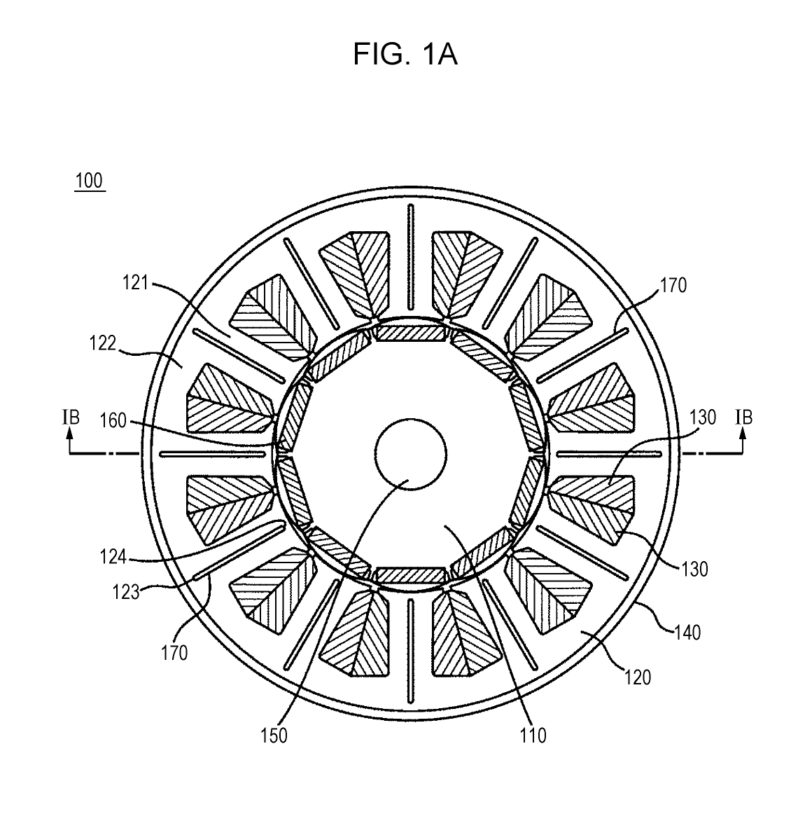

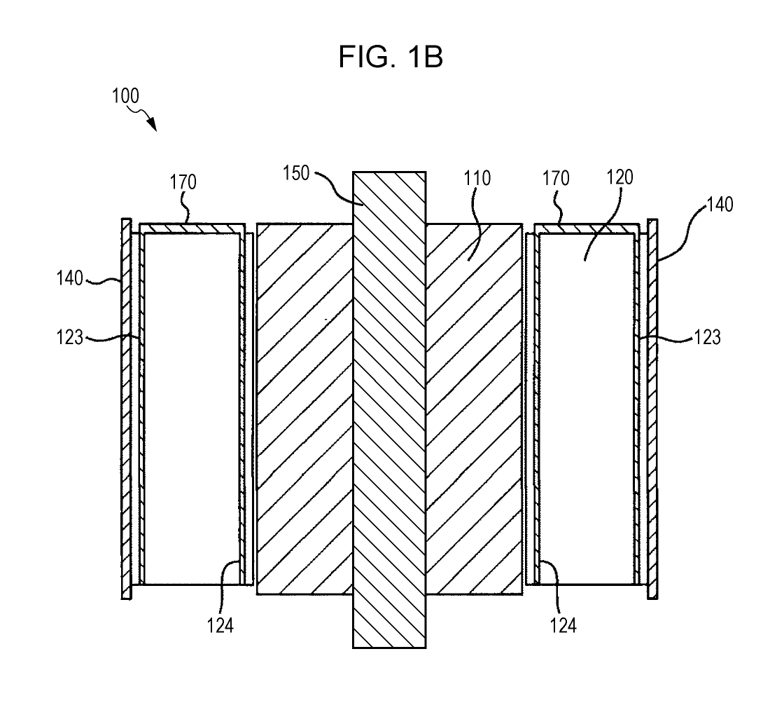

FIG. 1A is a plan view of a rotary machine 100 according to a first embodiment. FIG. 1B is a sectional view of the rotary machine 100 taken along line IB-IB in FIG. 1A. In FIG. 1A and FIG. 1B, the rotary machine 100 according to the first embodiment is an electric motor or a generator. The rotary machine 100 includes a rotor 110, a stator 120, coils 130, a frame 140, a shaft 150, permanent magnets 160, and insertion members 170. The stator 120 and the frame 140 are secured to each other by, for example, shrink fitting. The frame 140 secures and holds the outer edge of the stator 120.

In FIG. 1A and FIG. 1B, the rotor 110 is disposed inside the stator 120, and the coils 130 are wound inside the stator 120. The permanent magnets 160 are disposed on the outer circumferential portion of the rotor 110 at a predetermined interval so as to face the coils 130. The stator 120 includes tooth portions 121 and yoke portions 122. The stator 120 also includes the insertion members 170, each of which is disposed between the adjoining coils 130, and is inserted into insertion holes 123 and 124 to apply a stress T to the stator 120. The insertion holes 123 and 124 extend through the stator 120 in the thickness direction. The insertion holes 123 and 124 are, for example, circular.

In the rotary machine 100, when an electric current flows through the coils 130, the rotor 110 rotates about the shaft 150. Thus, the rotary machine 100 functions as an electric motor. When the rotation of the shaft 150 causes the rotor 110 to rotate, an electromotive force is created in each coil 130, and accordingly, the rotary machine 100 functions also as a generator.

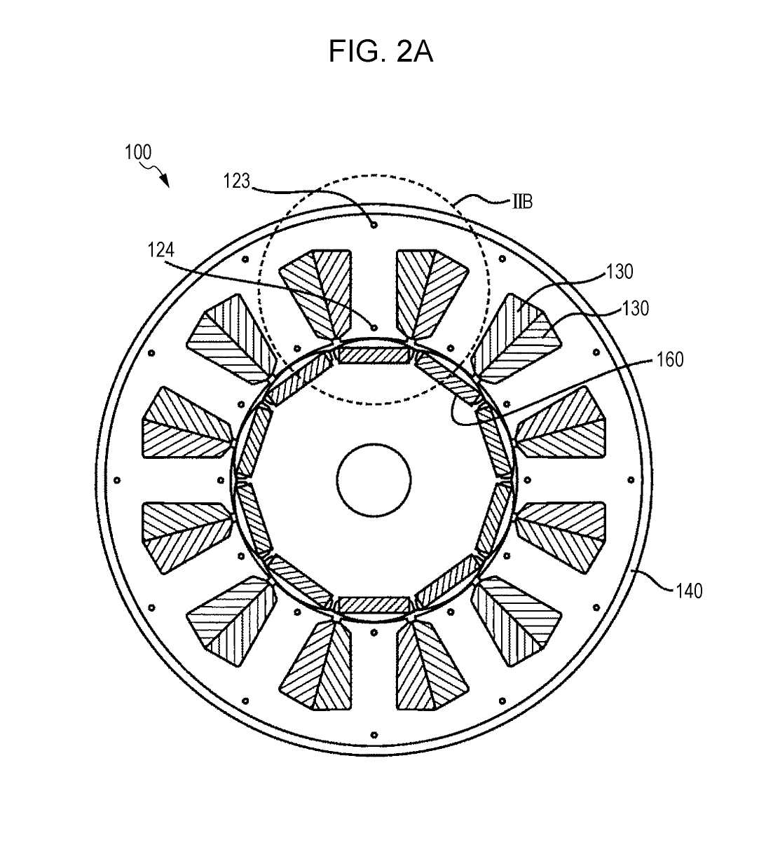

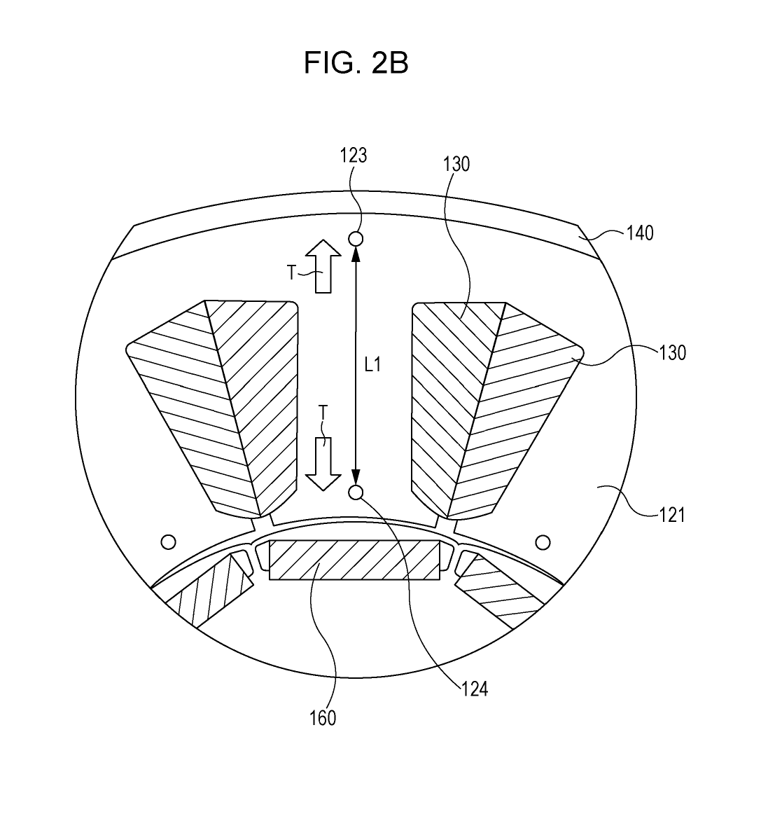

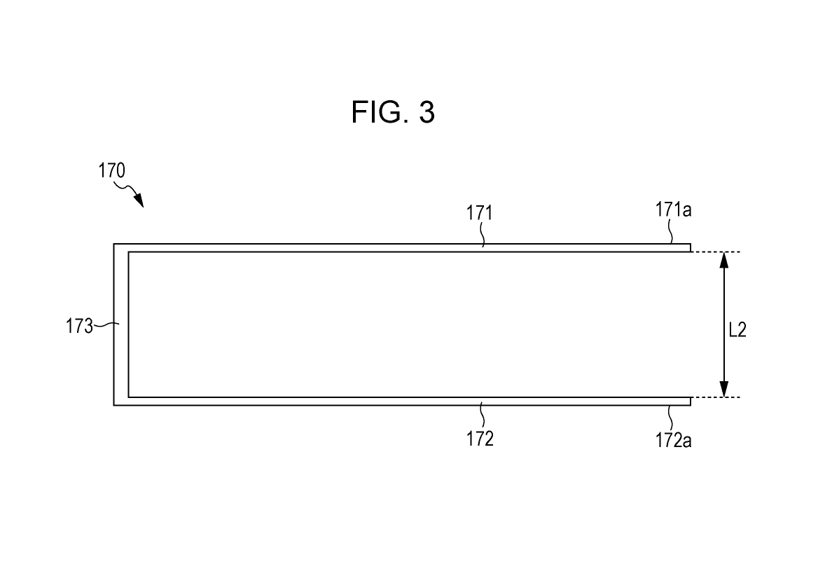

FIG. 2A is a plan view of the rotary machine 100 in FIG. 1A before the insertion members 170 are inserted. FIG. 2B is an enlarged view of a portion IIB in FIG. 2A. FIG. 3 is a side view of one of the insertion members 170 used in the rotary machine 100 in FIG. 1A.

In FIG. 2A and FIG. 2B, the insertion holes 123 are formed in the respective tooth portions 121 near the outer circumference portion of the tooth portions 121. The insertion holes 124 are formed in the respective tooth portions 121 near the inner circumferential portion of the tooth portions 121. Each tooth portion 121 faces the insertion hole 123 in the same tooth portion 121. As illustrated in FIG. 3, each insertion member 170 is formed in a U-shape and includes protrusions 171 and 172 extending in the thickness direction of the stator 120 and a connection 173 connecting the protrusions 171 and 172 to each other. The protrusions 171 and 172 are inserted into the insertion hole 123 and 124, respectively. The connection 173 is disposed on an end surface of the corresponding tooth portion 121 of the stator 120. As illustrated in FIG. 1B, the insertion members 170 are thus completely inserted. The insertion member 170 is disposed for each of the tooth portions 121.

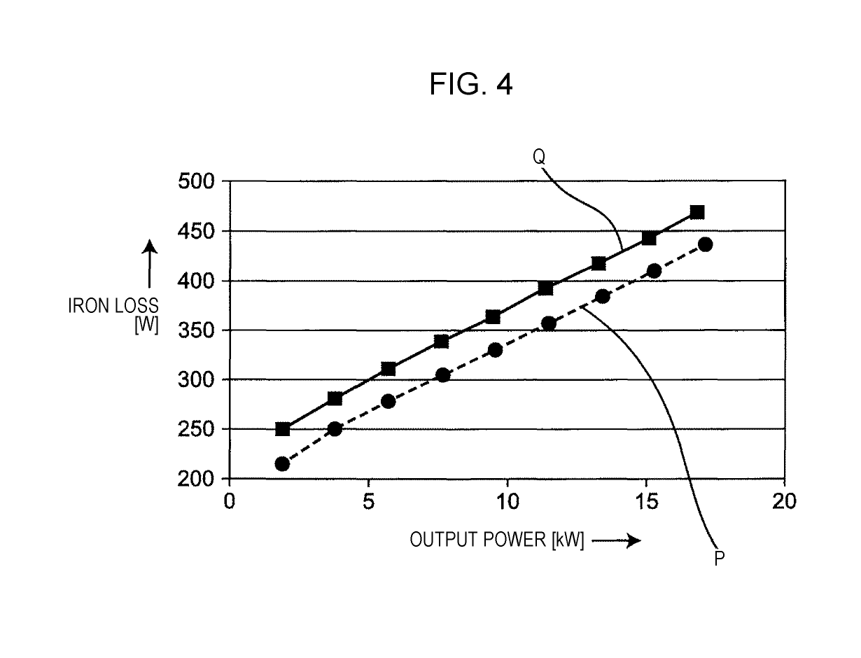

The distance L2 (see FIG. 3) between the protrusions 171 and 172 of each insertion member 170 is larger than the distance L1 (see FIG. 2B) between the corresponding insertion hole 123 and insertion hole 124. In this way, a tensile stress T can be applied to the tooth portions 121. With the above structure, since the tensile stress T can be applied to the tooth portions 121, as illustrated in FIG. 4, the magnetic characteristics of the tooth portions 121 can be improved, and iron loss can be reduced.

FIG. 4 is a graph illustrating iron loss with respect to the output power of the rotary machine 100 in FIG. 1A in the case where a tensile stress is applied (line P) and in the case where no tensile stress is applied (line Q). In FIG. 4, the characteristics of the rotary machine 100 when a tensile stress is applied is illustrated by a dashed line, and the characteristics of the rotary machine 100 when no tensile stress is applied is illustrated by a solid line. FIG. 4 illustrates iron loss with respect to the output power in the case where the rotor 110 and the stator 120 are made of electrical steel sheets of JIS 35A300 and in the case where a tensile stress of 20 MPa is applied to the tooth portions 121. As is obvious from FIG. 4, in the case of an output power of 2 kW, iron loss can be reduced by about 30 W and the efficiency can be improved by about 1.5% when a tensile stress of 20 MPa is applied to the tooth portions 121.

The amount of magnetic flux through each insertion member 170 can be decreased when the insertion member 170 is made of a non-magnetic material. This prevents a decrease in the amount of magnetic flux contributing to the torque of the rotary machine. An eddy current through each insertion member 170 can be decreased when the insertion member 170 is made of an insulating material. This prevents a decrease in efficiency caused by a loss of the eddy current.

### Second Embodiment

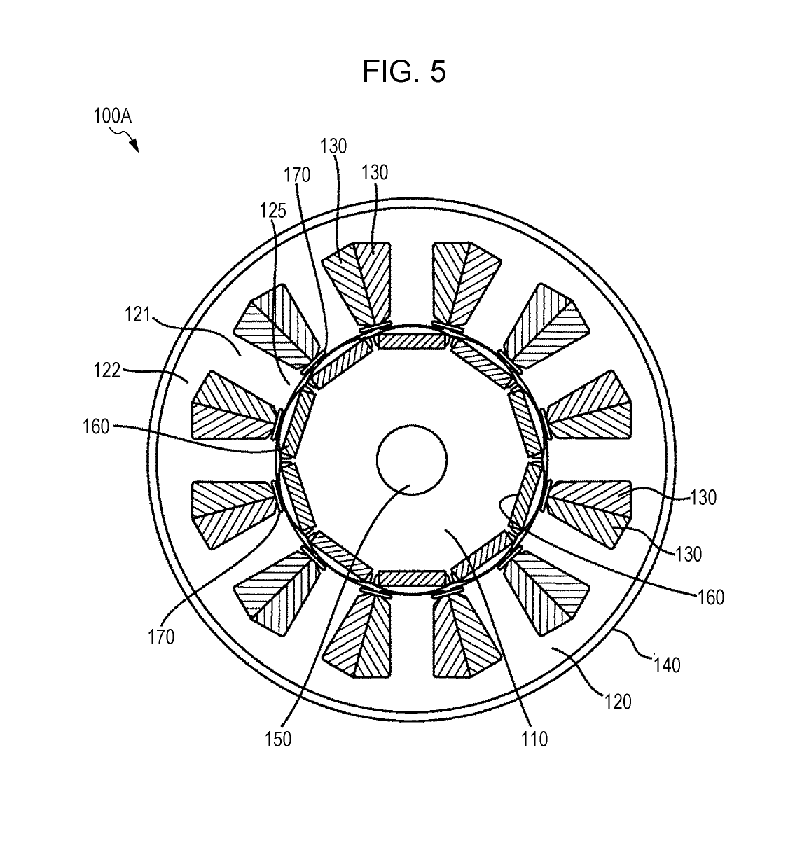

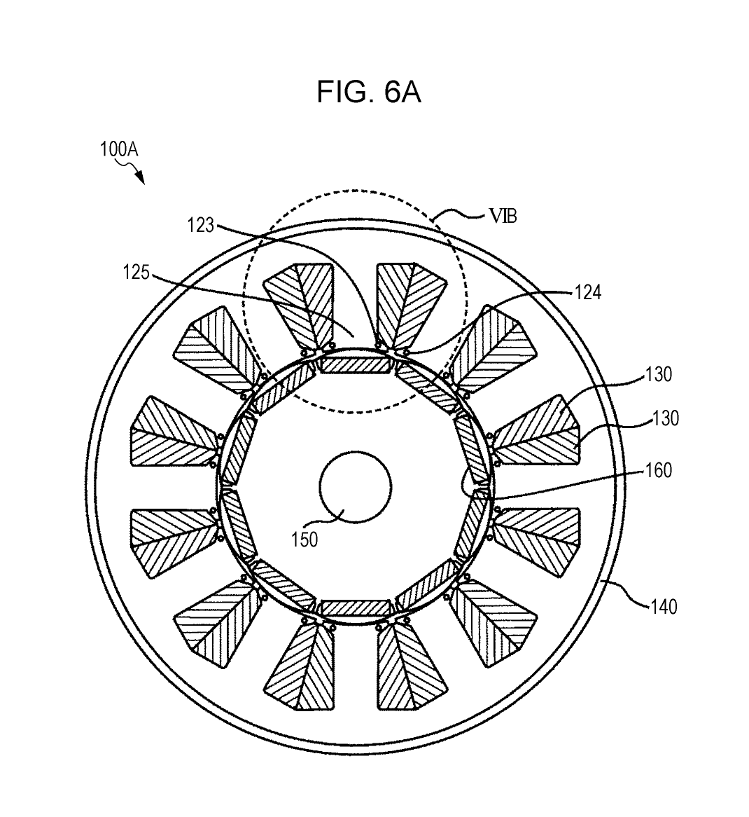

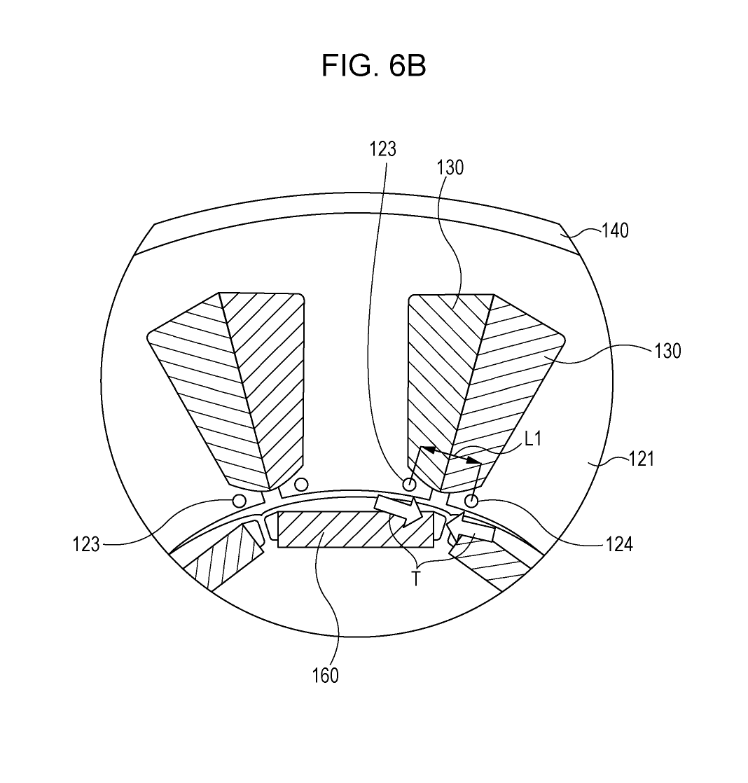

FIG. 5 is a plan view of a rotary machine 100A according to a second embodiment. FIG. 6A is a plan view of the rotary machine 100A in FIG. 5 before the insertion members 170 are inserted. FIG. 6B is an enlarged view of a portion VIB in FIG. 6A. In FIG. 5, FIG. 6A, and FIG. 6B, the rotary machine 100A according to the second embodiment differs from the rotary machine 100 according to the first embodiment in FIG. 1A and is characterized in that each insertion member 170 is inserted into a portion 125 near the inner circumference of the corresponding tooth portions 121. The portion 125 near the inner circumference is located between a portion at which the corresponding coils 130 are located and the inner circumference of the stator 120, for example, at a portion near the inner circumference of the stator 120.

According to the second embodiment, a stress can be applied to the portion 125 near the inner circumference of each tooth portion 121. For example, when L1>L2, a distance between the tip of the tooth portion 121 and the tip of another tooth portion 121 adjacent thereto decreases, and accordingly, the tensile stress T can be applied to the portion 125 near the inner circumference of each tooth portion 121.

### Third Embodiment

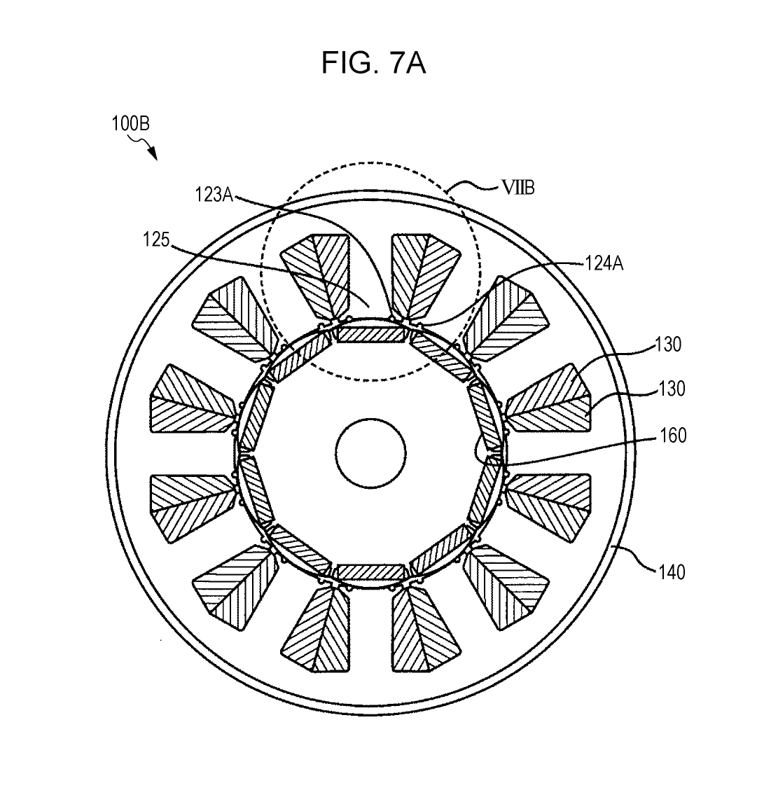

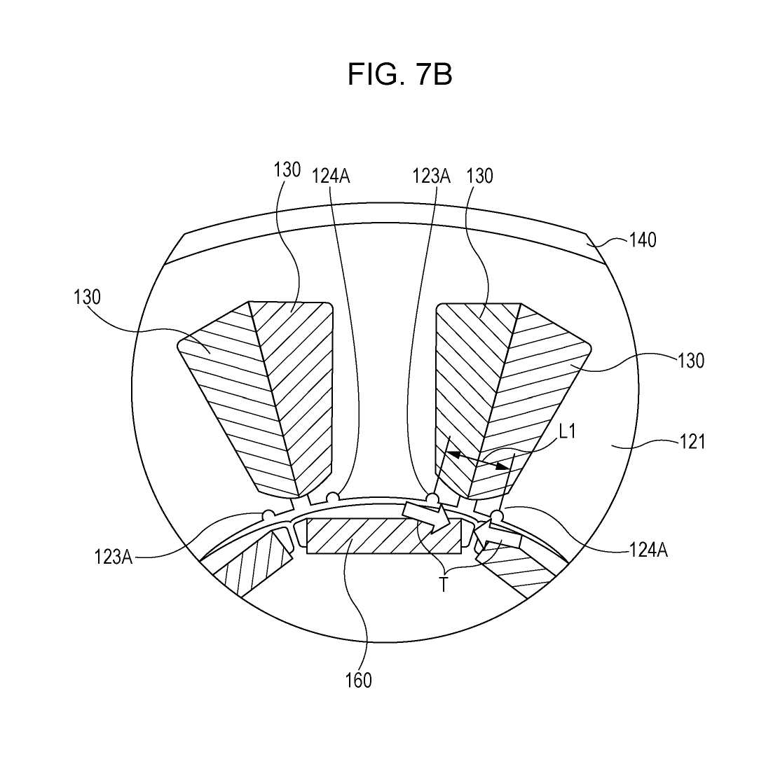

FIG. 7A is a plan view of a rotary machine 100B according to a third embodiment. FIG. 7B is an enlarged view of a portion VIIB in FIG. 7A. In the rotary machine 100B according to the third embodiment in FIG. 7A and FIG. 7B, each insertion hole has a shape different from the shape in the rotary machine 100A according to the second embodiment in FIG. 6A and FIG. 6B. Insertion holes 123A and 124A according to the third embodiment each have, for example, a substantially semicircular shape or a shape into which a circle is partially cut along a plane parallel to a tangent unlike the case of the circular insertion holes 123 and 124 according to the second embodiment. The plane parallel to the tangent passes through a portion nearer to the outer circumference of the circle rather than to the center of the circle. The insertion holes 123A and 124A are formed in the portion 125 near the inner circumference of each tooth portion 121.

The insertion holes 123 and 124, into which the insertion members 170 are inserted, are not necessarily circular and may have, for example, the shape illustrated in FIG. 7A and FIG. 7B provided that the insertion members 170 do not disengage. The size of the insertion holes 123A and 124A formed in the stator 120 can be smaller than in the first embodiment and the second embodiment when the insertion holes 123A and 124A are formed in the shape illustrated in FIG. 7A and FIG. 7B. This prevents magnetic saturation at the portion 125 near the inner circumference of each tooth portion 121.

According to the third embodiment, a stress can be applied to the portion 125 near the inner circumference of each tooth portion 121 as in the second embodiment. For example, when L1>L2, the distance between the tip of the tooth portion 121 and the tip of another tooth portion 121 adjacent thereto decreases, and accordingly, the tensile stress T can be applied to the portion 125 near the inner circumference of each tooth portion 121.

### Fourth Embodiment

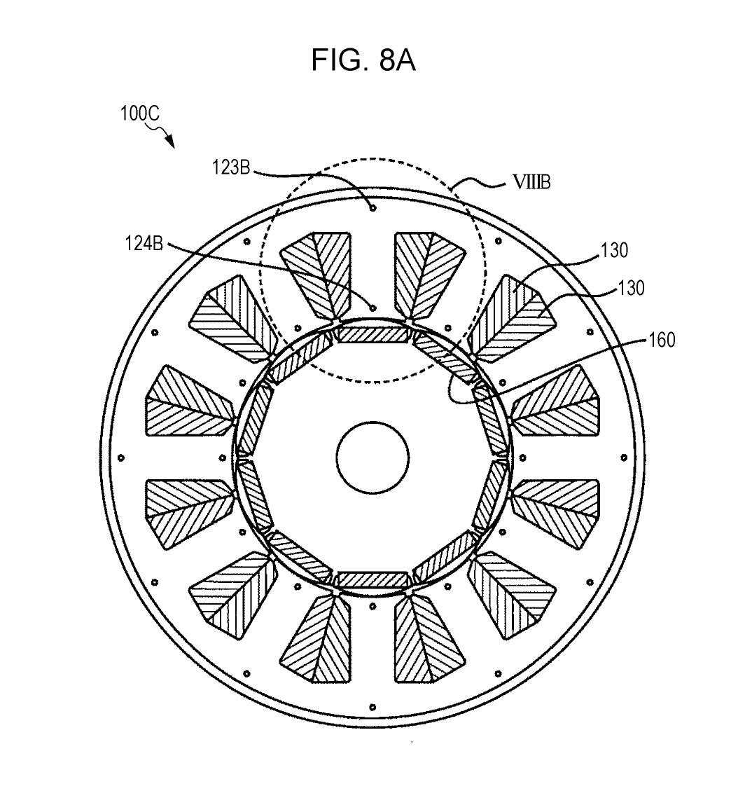

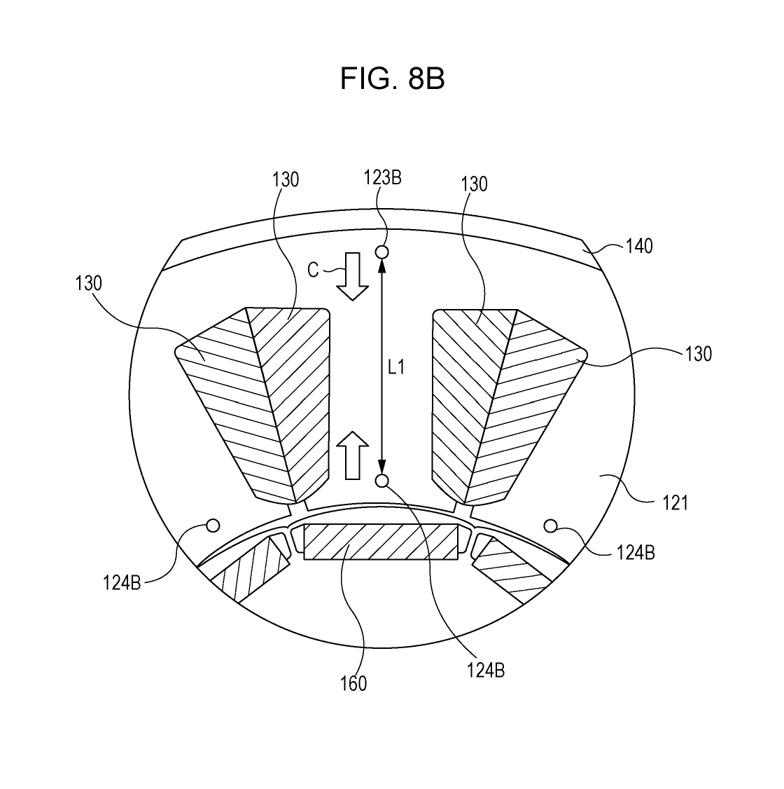

FIG. 8A is a plan view of a rotary machine 100C according to a fourth embodiment. FIG. 8B is an enlarged view of a portion VIIIB in FIG. 8A.

In the rotary machine 100C according to the fourth embodiment in FIG. 8A and FIG. 8B, a compressive stress C may be applied when L1>L2 is satisfied, as illustrated in FIG. 8B. Applying the compressive stress C enables magnetic flux to be unlikely to flow. For example, the tensile stress T may be applied to a portion of the stator 120 through which magnetic flux is intended to flow under the condition of L1<L2, and the compressive stress C may be applied to a portion of the stator 120 through which magnetic flux is not intended to flow under the condition of L1>L2.

### Fifth Embodiment

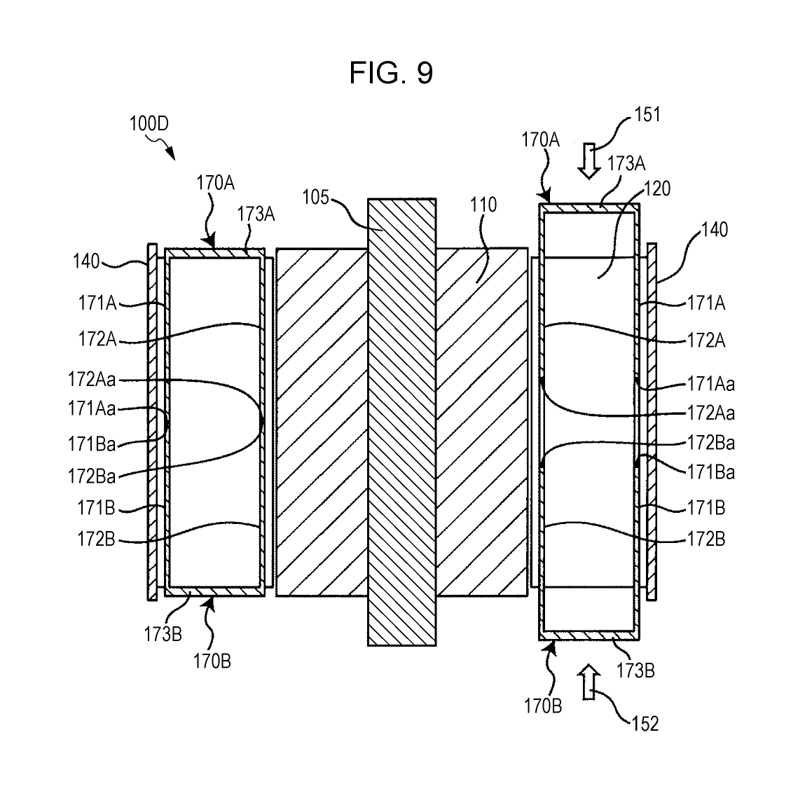

FIG. 9 is a sectional view of a rotary machine 100D according to a fifth embodiment. The rotary machine 100D according to the fifth embodiment in FIG. 9 differs from the rotary machine 100 according to the first embodiment in, for example, FIG. 1A in having insertion members 170A and 170B instead of the insertion members 170. The difference will now be described in detail.

Each insertion member 170 according to the first embodiment in FIG. 3 is formed in a U-shape and includes the protrusions 171 and 172 that respectively have end portions 171a and 172a at both tips and that extend in the thickness direction of the stator 120 and the connection 173 connecting the protrusions 171 and 172 to each other. The insertion members 170A and 170B according to the fifth embodiment in FIG. 9 are formed such that the protrusions 171 and 172 are divided into two parts as follows.

Each insertion member 170A is formed in a U-shape having end portions 171Aa and 172Aa at both tips and includes protrusions 171A and 172A extending in the thickness direction of the stator 120 and a connection 173A connecting the protrusions 171A and 172A to each other.

Each insertion member 170B is formed in a U-shape having end portions 171Ba and 172Ba at both tips and includes protrusions 171B and 172B extending in the thickness direction of the stator 120 and a connection 173B connecting the protrusions 171B and 172B.

The insertion members 170A are inserted from the upper end face of the rotary machine 100D in the direction of an arrow 151. The insertion members 170B are inserted from the lower end face of the rotary machine 100D in the direction of an arrow 152.

According to the fifth embodiment, the tensile stress T can be applied uniformly to the rotary machine 100D having a long length in the axial direction.

### Modification

In examples described in the embodiments, a stress is applied to the stator 120. However, in the case where a stress is applied not only to the stator 120 but also to the rotor 110, the same effects can be achieved.

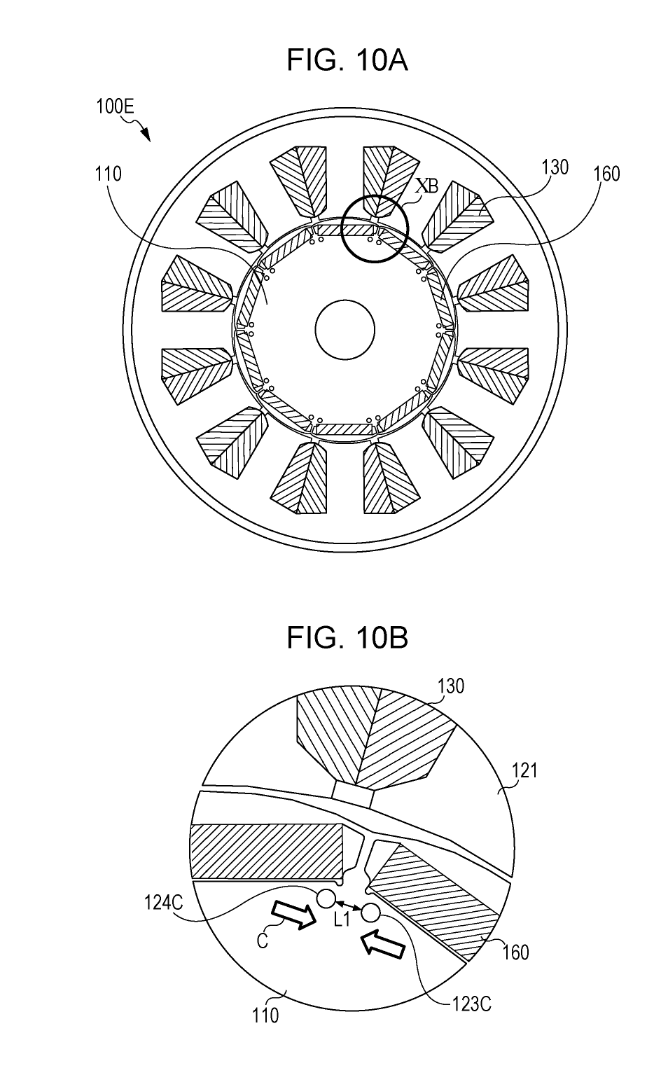

FIG. 10A is a plan view of a rotary machine 100E according to a modification before the insertion members 170 are inserted. FIG. 10B is an enlarged view of a portion XB in FIG. 10A.

As illustrated in FIG. 10A and FIG. 10B, in the rotary machine 100E, insertion holes 123C and 124C are formed near the outer circumference of the rotor 110. The distance L1 between the adjoining insertion holes 123C and 124C is longer than the length L2 of the connection 173 of each insertion member 170. Thus, the compressive stress C is applied to the vicinity of the outer circumference of the rotor 110.

What is claimed is:

1. A rotary machine, comprising:
a rotor;
a stator;
a first hole and a second hole that are provided in at least one selected from the group consisting of the rotor and the stator; and
a first insertion member including a first protrusion inserted into the first hole, a second protrusion inserted into the second hole, and a first connection connecting the first protrusion and the second protrusion to each other,
wherein a distance between the first hole and the second hole differs from a length of the first connection.

2. The rotary machine according to claim 1, further comprising:
a frame holding an outer edge of the stator.

3. The rotary machine according to claim 1, further comprising:
a third hole and a fourth hole that are provided in at least one selected from the group consisting of the rotor and the stator; and
a second insertion member including a third protrusion inserted into the third hole, a fourth protrusion inserted into the fourth hole, and a second connection connecting the third protrusion and the fourth protrusion to each other, wherein:
the distance between the first hole and the second hole is shorter than the length of the first connection, and
a distance between the third hole and the fourth hole is longer than a length of the second connection.

4. The rotary machine according to claim 1, further comprising:
a third hole and a fourth hole that are provided in at least one selected from the group consisting of the rotor and the stator; and
a second insertion member including a third protrusion inserted into the third hole, a fourth protrusion inserted into the fourth hole, and a second connection connecting the third protrusion and the fourth protrusion to each other, wherein:
the distance between the first hole and the second hole is shorter than the length of the first connection, and
a distance between the third hole and the fourth hole is shorter than a length of the second connection.

5. The rotary machine according to claim 1, further comprising:
a third hole and a fourth hole that are provided in at least one selected from the group consisting of the rotor and the stator; and
a second insertion member including a third protrusion inserted into the third hole, a fourth protrusion inserted into the fourth hole, and a second connection connecting the third protrusion and the fourth protrusion to each other, wherein:
the distance between the first hole and the second hole is longer than the length of the first connection, and
a distance between the third hole and the fourth hole is longer than a length of the second connection.

6. The rotary machine according to claim 3, wherein:
the stator includes a first tooth and a second tooth,
the first hole and the second hole are provided in the first tooth, and
the third hole and the fourth hole are provided in the second tooth.

7. The rotary machine according to claim 1, further comprising:
a third hole connected to the first hole;
a fourth hole connected to the second hole; and
a second insertion member including a third protrusion inserted into the third hole, a fourth protrusion inserted into the fourth hole, and a second connection connecting the third protrusion and the fourth protrusion to each other, wherein:
the at least one selected from the group consisting of the rotor and the stator has a first surface perpendicular to a shaft of the rotary machine and a second surface opposite to the first surface,
the first hole and the second hole extend from the first surface, and
the third hole and the fourth hole extend from the second surface.

8. The rotary machine according to claim 3, further comprising:
a fifth hole connected to the first hole;
a sixth hole connected to the second hole;
a third insertion member including a fifth protrusion inserted into the fifth hole, a sixth protrusion inserted into the sixth hole, and a third connection connecting the fifth protrusion and the sixth protrusion;
a seventh hole connected to the third hole;
an eighth hole connected to the fourth hole; and
a fourth insertion member including a seventh protrusion inserted into the seventh hole, an eighth protrusion inserted into the eighth hole, and a fourth connection connecting the seventh protrusion and the eighth protrusion to each other, wherein:
the at least one selected from the group consisting of the rotor and the stator has a first surface perpendicular to a shaft of the rotary machine and a second surface opposite to the first surface,
the first hole, the second hole, the third hole, and the fourth hole extend from the first surface, and
the fifth hole, the sixth hole, the seventh hole, and the eighth hole extend from the second surface.

9. The rotary machine according to claim 8, wherein:
a distance between the fifth hole and the sixth hole is shorter than a length of the third connection, and
a distance between the seventh hole and the eighth hole is longer than a length of the fourth connection.

10. The rotary machine according to claim 1,
wherein the first insertion member is composed of a non-magnetic material.

11. The rotary machine according to claim 1,
wherein the first insertion member is composed of an insulating material.

12. The rotary machine according to claim 3,
wherein the first insertion member and the second insertion member are composed of a non-magnetic material.

13. The rotary machine according to claim 3,
wherein the first insertion member and the second insertion member are composed of an insulating material.

14. The rotary machine according to claim 7,
wherein the first insertion member and the second insertion member are composed of a non-magnetic material.

15. The rotary machine according to claim 7,
wherein the first insertion member and the second insertion member are composed of an insulating material.
